(19) United States
(12) Patent Application Publication
(10) Pub. No.: US 2013/0219157 A1
(43) Pub. Date: Aug. 22, 2013

(54) MOBILE TERMINAL AND CONTROLLING METHOD THEREOF

(71) Applicants: Jungseok LEE, Seoul (KR); Giwon Kang, Seoul (KR); Hyeonchang Choi, Seoul (KR); Hongjo Shim, Seoul (KR)

(72) Inventors: Jungseok LEE, Seoul (KR); Giwon Kang, Seoul (KR); Hyeonchang Choi, Seoul (KR); Hongjo Shim, Seoul (KR)

(21) Appl. No.: 13/772,668

(22) Filed: Feb. 21, 2013

Related U.S. Application Data
(60) Provisional application No. 61/602,018, filed on Feb. 22, 2012.

(30) Foreign Application Priority Data
May 14, 2012 (KR) 10-2012-0050736

(51) Int. Cl. G06F 1/24

(52) U.S. Cl. CPC G06F 1/24
USPC 713/1

(57) ABSTRACT

A mobile terminal and controlling method thereof are disclosed, by which a setting of a low power wireless communication module can be automatically reseted if the mobile terminal is turned on. The present invention includes a power supply unit, an application processor, a low power wireless communication module configured to maintain an active state by being supplied with the power from the power supply unit despite that the mobile terminal is in an inactive state, the low power wireless communication module set to be cut off a signal inputted from the application processor if the application processor is in the inactive state, and a reset circuit receiving a trigger signal from the application processor after activation of the application processor, the reset circuit resetting a setting of the low power wireless communication module based on the trigger signal.

Pursuant to 35 U.S.C. §119(a), this application claims the benefit of the Korean Patent Application No. 10-2012-0050736, filed on May 12, 2012 and Pursuant to 35 U.S.C. 119(e) the benefit of U.S. Provisional Application No. 61/602,018, filed on Feb. 22, 2012, which are hereby incorporated by reference as if fully set forth herein.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for facilitating a terminal to be used in further consideration of user's convenience.

2. Discussion of the Related Art

Generally, terminals can be classified into mobile/portable terminals and stationary terminals. The mobile terminals can be classified into handheld terminals and vehicle mount terminals again according to possibility of user's direct portability.

As functions of the terminal are diversified, the terminal is implemented as a multimedia player provided with composite functions such as photographing of photos or moving pictures, playback of music or moving picture files, game play, broadcast reception and the like for example.

To support and increase of the terminal functions, it may be able to consider the improvement of structural part and/or software part of the terminal.

In order to enhance functions of a mobile terminal, various kinds of wireless communication chips are loaded on the mobile terminal. In particular, as a mobile terminal has such a power saving short-range communication module loaded thereon as NFC, Bluetooth, Zigbee and the like, its applicable fields are increasingly extending to various fields including fee payment, door entrance system, audio output via Bluetooth speaker and the like.

Especially, the ongoing demands for using the aforementioned communication modules for the fee payment, the door entrance system are increasingly rising. FIG. 1 shows the configuration of a mobile terminal to utilize a low power, wireless communication module continuously despite that a power of a mobile terminal is turned off. The problems of the related art are described in detail with reference to FIG. 1 as follows.

FIG. 1 is a block diagram to describe the chipset connection relation between an application processor 2 and a low power wireless communication module 3 according to a related art.

Referring to FIG. 1, while an application processor 2 is operating by being supplied with a power, such a low power wireless communication module 3 as a Bluetooth module, an NFC communication module, a Zigbee communication module and the like operated under the control of the application processor 2 [FIG. 1 (a)]. In particular, the low power wireless communication module 3 is able to operate in a manner of receiving a control signal consisting of a digital signal of ‘0 (Low)’ or ‘1 (High)’ by being connected to GPIO (general purpose input/output) pins.

In case of the low power wireless communication module 3, since a power consumption level required for maintaining activation of the low power wireless communication module 3 can be maintained on a considerably low, even if a remaining power level of a power supply unit 1 is low, the Bluetooth module can be operated for long term. Hence, referring to FIG. 1 (b), the low power wireless communication module 3 can be set to maintain a communication state by being continuously supplied with power despite that the power has already stop being supplied to the application processor 2.

Yet, after the power supply to the application processor 2 has stopped, it may become unclear whether a signal applied to the low power wireless communication module via the GPIO pin of the application processor 2 is ‘0 (Low)’ or ‘1 (High)’. Thus, the signal inputted to the low power wireless communication module 3 after stopping the power supply to the application processor 2 may be handled as noise that interrupts a normal operation of the low power wireless communication module 3. Therefore, in order to activate the low power wireless communication module 3 after the cutoff of the power supply to the application processor 2, the low power wireless communication module 3 needs to be set to cut off a signal inputted from the application processor 2.

Even if the low power wireless communication module 3 is set to cut off the signal inputted from the application processor 2, it is supposed to operate under the control of the application processor 2 since a timing point of applying a power to the application processor 2. In particular, the setting for the low power wireless communication module 3 to cut off the signal inputted from the application processor 2 should be cancelled after activation of the application processor 2. Otherwise, even if the application 2 is activated, the low power wireless communication module 3 is not controlled by the application processor 2, it may cause a problem that the low power wireless communication module 3 is uncontrollable via a user input.

Thus, in order to enable the low power wireless communication module 3 to keep operating despite turning off the mobile terminal shown in FIG. 1, since the low power wireless communication module 3 is set to cut off all signals inputted from the application processor 2, it causes a problem that the low power wireless communication module 3 is not controllable after the activation of the application processor 2. In particular, even if the application processor 2 is awakened, it may have problem of having difficulty in transmitting a signal, which indicates that the application processor 2 has been awakened, to the low power wireless communication module 3 effectively. Eventually, the low power wireless communication module 3 keeps operating without being controlled by the application processor 2 despite that the application processor 2 is activated, thereby causing a problem that a user is unable to appropriately control the low power wireless communication module 3 to use.

### SUMMARY OF THE INVENTION

Accordingly, embodiments of the present invention are directed to a mobile terminal and controlling method thereof that substantially obviate one or more problems due to limitations and disadvantages of the related art.

One object of the present invention is to provide a mobile terminal and controlling method thereof, by which a setting of a low power wireless communication module configured to maintain its active state despite an off-state of the mobile terminal can be automatically initialized if the mobile terminal is turned on.

Another object of the present invention is to provide a mobile terminal and controlling method thereof, by which a low power wireless communication module 3 can operate effectively despite that the mobile terminal is in off-state.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a mobile terminal according to the present invention may include a power supply unit configured to supply an operation power, an application processor activated by being supplied with a power from the power supply unit, a low power wireless communication module configured to maintain an active state by being supplied with the power from the power supply unit despite that the mobile terminal is in an inactive state, the low power wireless communication module set to be cut off a signal inputted from the application processor if the application processor is in the inactive state, and a reset circuit receiving a trigger signal from the application processor after activation of the application processor, the reset circuit initializing a setting of the low power wireless communication module based on the trigger signal.

In another aspect of the present invention, a method of controlling a mobile terminal having a low power wireless communication module configured to maintain an active state by being supplied with a power from a power supply unit despite that an application processor is in an inactive state, according to the present invention may include the steps of switching the inactive state of the application processor to the active state, providing a trigger signal to a reset circuit to enable the application processor to initialize a setting of the low power wireless communication module, and controlling the reset circuit to initialize the setting of the low power wireless communication module based on the trigger signal.

Effects obtainable from the present invention may be non-limited by the above mentioned effect. And, other unmentioned effects can be clearly understood from the following description by those having ordinary skill in the technical field to which the present invention pertains.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a block diagram to describe the chipset connection relation between an application processor 2 and a low power wireless communication module 3 according to a related art;

FIG. 2 is a block diagram of a mobile terminal according to one embodiment of the present invention;

FIG. 3A is a front perspective diagram of a mobile terminal according to one embodiment of the present invention;

FIG. 3B is a rear perspective diagram of a mobile terminal according to one embodiment of the present invention;

FIG. 4 is a block diagram of a mobile terminal including a reset circuit according to the present invention;

FIG. 5 is a flowchart for operation of a mobile terminal according to the present invention;

FIG. 6 is a diagram of display screen configuration provided to enable a user set up whether to independently operate a low power wireless communication module;

FIG. 7 is a graph of operation of a Bluetooth module that is a low power wireless communication module;

FIG. 8 is a diagram of circuitry to describe a reset circuit according to one embodiment of the present invention;

FIG. 9 is a diagram of circuitry to describe a reset circuit according to one embodiment of the present invention;

FIG. 10 is a diagram for one example of circuitry in case of resetting a low power wireless communication module when a reset circuit is directly connected to the low power wireless communication module; and

FIG. 11 is a diagram for another example of circuitry in case of resetting a low power wireless communication module when a reset circuit is directly connected to the low power wireless communication module.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. The suffixes ‘module’ and ‘unit’ for the elements used in the following description are given or used in common by considering facilitation in writing this disclosure only but fail to have meanings or roles discriminated from each other.

First of all, mobile terminals described in this disclosure can include a mobile phone, a smart phone, a laptop computer, a digital broadcast terminal, a PDA (personal digital assistants), a PMP (portable multimedia player), a navigation system and the like.

Except a case applicable to a mobile terminal only, it is apparent to those skilled in the art that the configurations according to an embodiment described in this disclosure is applicable to such a stationary terminal as a digital TV, a desktop computer and the like.

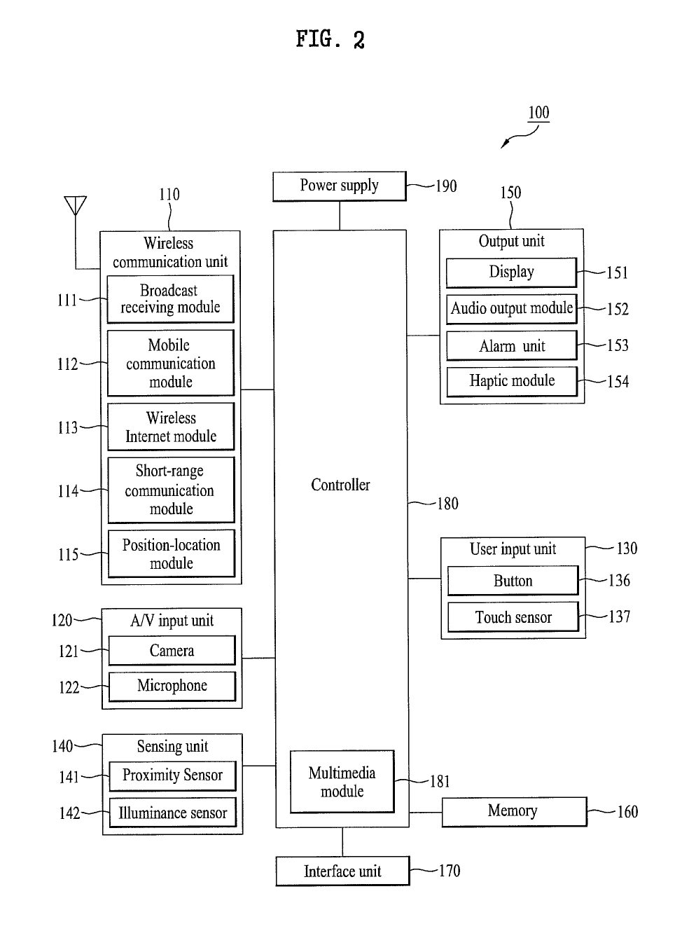

FIG. 2 is a block diagram of a mobile terminal according to one embodiment of the present invention.

Referring to FIG. 2, a mobile terminal 100 according to one embodiment of the present invention includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 2 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel.

The broadcast channel may include a satellite channel and a terrestrial channel.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.). Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), etc.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

Referring to FIG. 2, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display unit 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc.

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100. As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display unit 151, an audio output module 152, an alarm unit 153, a haptic module 154, a projector module 155 and the like.

The display unit 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display unit 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display unit 151 can be implemented in the optical transmittive type as well. In this configuration, a user is able to see an object in rear of a terminal body via the area occupied by the display unit 151 of the terminal body.

At least two display units 151 can be provided to the mobile terminal 100 in accordance with the implemented configuration of the mobile terminal 100. For instance, a plurality of display units can be arranged on a single face of the mobile terminal 100 in a manner of being spaced apart from each other or being built in one body. Alternatively, a plurality of display units can be arranged on different faces of the mobile terminal 100.

In case that the display unit 151 and a sensor for detecting a touch action (hereinafter called ‘touch sensor’) configures a mutual layer structure (hereinafter called ‘touchscreen’), it is able to use the display unit 151 as an input device as well as an output device. In this case, the touch sensor can be configured as a touch film, a touch sheet, a touchpad or the like.

The touch sensor can be configured to convert a pressure applied to a specific portion of the display unit 151 or a variation of a capacitance generated from a specific portion of the display unit 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display unit 151 is touched.

Referring to FIG. 2, a proximity sensor (not shown in the drawing) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

In the following description, for clarity, an action that a pointer approaches without contacting with the touchscreen to be recognized as located on the touchscreen is named ‘proximity touch’. And, an action that a pointer actually touches the touchscreen is named ‘contact touch’. The meaning of the position on the touchscreen proximity-touched by the pointer means the position of the pointer which vertically opposes the touchscreen when the pointer performs the proximity touch.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display unit 151 or the audio output unit 152. Hence, the display unit 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The projector module 155 is the element for performing an image projector function using the mobile terminal 100. And, the projector module 155 is able to display an image, which is identical to or partially different at least from the image displayed on the display unit 151, on an external screen or wall according to a control signal of the controller 180.

In particular, the projector module 155 can include a light source (not shown in the drawing) generating light (e.g., laser) for projecting an image externally, an image producing means (not shown in the drawing) for producing an image to output externally using the light generated from the light source, and a lens (not shown in the drawing) for enlarging to output the image externally in a predetermined focus distance. And, the projector module 155 can further include a device (not shown in the drawing) for adjusting an image projected direction by mechanically moving the lens or the whole module.

The projector module 155 can be classified into a CRT (cathode ray tube) module, an LCD (liquid crystal display) module, a DLP (digital light processing) module or the like according to a device type of a display means. In particular, the DLP module is operated by the mechanism of enabling the light generated from the light source to reflect on a DMD (digital micro-mirror device) chip and can be advantageous for the downsizing of the projector module 151.

Preferably, the projector module 155 can be provided in a length direction of a lateral, front or backside direction of the mobile terminal 100. And, it is understood that the projector module 155 can be provided to any portion of the mobile terminal 100 according to the necessity thereof.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures, moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

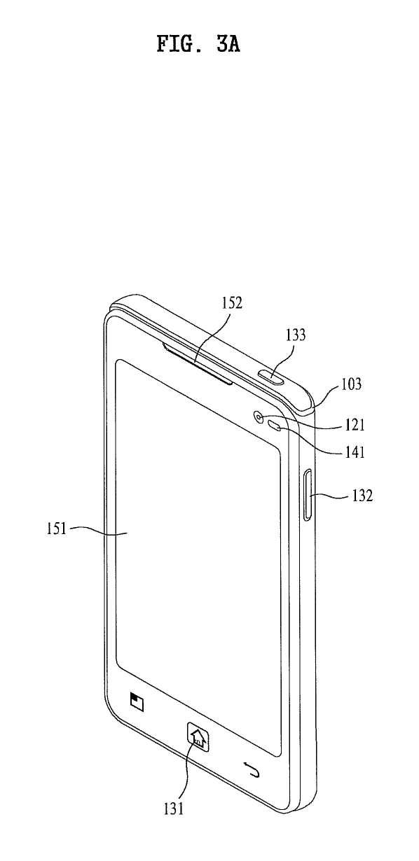

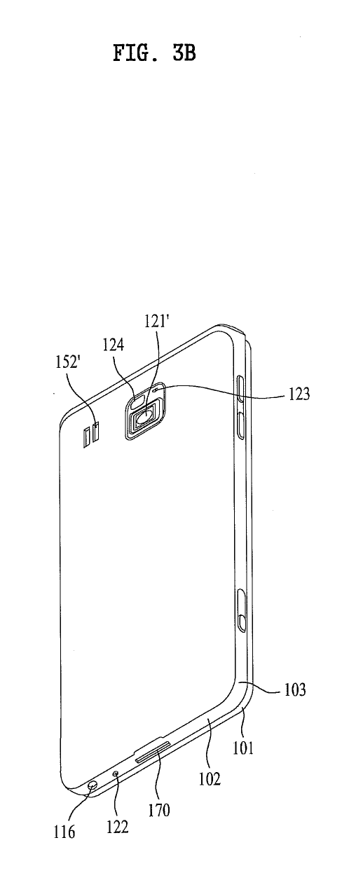

FIG. 3A is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 3A, the mobile terminal 100 includes a case (casing, housing, cover, etc.) configuring an exterior thereof. In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

The cases 101 and 102 are formed by injection molding of synthetic resin or can be formed of metal substance such as stainless steel (STS), titanium (Ti) or the like for example.

A display unit 151, an audio output unit 152, a camera 121, user input units 130/131 and 132, a microphone 122, an interface 180 and the like can be provided to the terminal body, and more particularly, to the front case 101.

The display unit 151 occupies most of a main face of the front case 101. The audio output unit 151 and the camera 121 are provided to an area adjacent to one of both end portions of the display unit 151, while the user input unit 131 and the microphone 122 are provided to another area adjacent to the other end portion of the display unit 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display unit 151 or the like can be inputted to the second manipulating unit 132.

FIG. 3B is a perspective diagram of a backside of the terminal shown in FIG. 3A.

Referring to FIG. 3B, a camera 121′ can be additionally provided to a backside of the terminal body, and more particularly, to the rear case 102. The camera 121 has a photographing direction that is substantially opposite to that of the former camera 121 shown in FIG. 3A and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 3A and may be used for implementation of a speakerphone mode in talking over the terminal.

A broadcast signal receiving antenna 124 can be additionally provided to the lateral side of the terminal body as well as an antenna for communication or the like. The antenna 124 constructing a portion of the broadcast receiving module 111 shown in FIG. 2 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad 135 for detecting a touch can be additionally provided to the rear case 102. The touchpad 135 can be configured in a light transmittive type like the display unit 151. In this case, if the display unit 151 is configured to output visual information from its both faces, it is able to recognize the visual information via the touchpad 135 as well. The information outputted from both of the faces can be entirely controlled by the touchpad 135. Alternatively, a display is further provided to the touchpad 135 so that a touchscreen can be provided to the rear case 102 as well.

The touchpad 135 is activated by interconnecting with the display unit 151 of the front case 101. The touchpad 135 can be provided in rear of the display unit 151 in parallel. The touchpad 135 can have a size equal to or smaller than that of the display unit 151.

In the following description, various embodiments related to a controlling method implemented in the above-configured mobile terminal shall be explained with reference to the accompanying drawings.

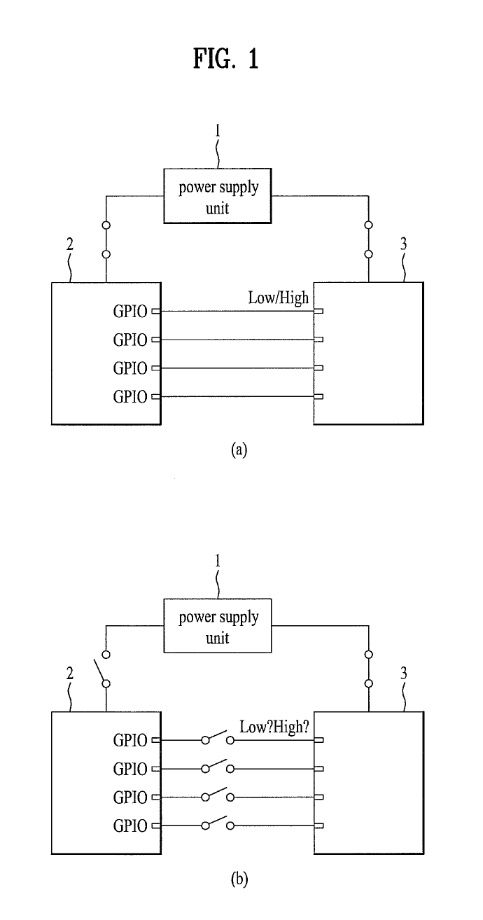

For clarity of the following description, a mobile terminal 100 mentioned in the following is assumed as including at least one of the components of the former mobile terminal shown in FIG. 2. In particular, a mobile terminal according to the present invention may be able to include the wireless communication unit 110, the controller 180 and the power supply unit 190 among the components shown in FIG. 2 at least. In particular, the present invention may be able to include an application processor 200 contained in the controller 180 and a low power wireless communication module 300 contained in the wireless communication unit 110. Besides, the present invention may be able to further include a reset circuit 400 (not shown in FIG. 1).

Mainly concerning the hardware structure of the controller 180, the present invention shall be described in detail as follows. First of all, an application processor 200 included in the controller 180 may be understood as a sort of SoC (system on chip) having both a function of performing a command execution operation by activating an operating system (OS) and a function of controlling the wireless communication unit 110.

Such a configuration, in which an operating device, a decryption device, a control device and the like are integrated on a single part, as the application processor 200 may be called a microprocessor. Thus, the application processor 200 mentioned in the description of the present invention may be understood as having the same meaning of the microprocessor.

The low power wireless communication module 300 included in the wireless communication unit 110 is a sort of a wireless communication unit that is sorted out by power consumption level. In particular, the low power wireless communication module 300 is a wireless communication module supportive of a power saving mode (hereinafter abbreviated PSM) and may include a wireless communication module configured to receive external signals by repeating ‘sleep’ and ‘wake up’ after entering the power saving mode.

For instance, the low power wireless communication module 300 may be conceptionally understood as including such a communication chip supportive of a power saving mode as a Bluetooth module, a Zigbee module, an NFC (near field communication) module, an RFID module and the like (i.e., contact-type short range communication modules, non-contact type short range communication modules). In case that the low power wireless communication module 300 includes the Bluetooth module, Bluetooth 4.0 version or higher is preferably applied to the Bluetooth module to support Bluetooth Low Energy (BLE), by which the present invention may be non-limited.

In the above description of the short range communication modules, the low power wireless communication module 300 is taken as the example. Yet, it may be unnecessary for the low power wireless communication module 300 to be limited to the short range wireless communication. For instance, as a solution supportive of a power saving mode is applied to the wireless internet module or the mobile communication module shown in FIG. 1, if the corresponding communication module is operable in power saving mode, the corresponding communication module may be regarded as belonging to the scope of the low power wireless communication module 300.

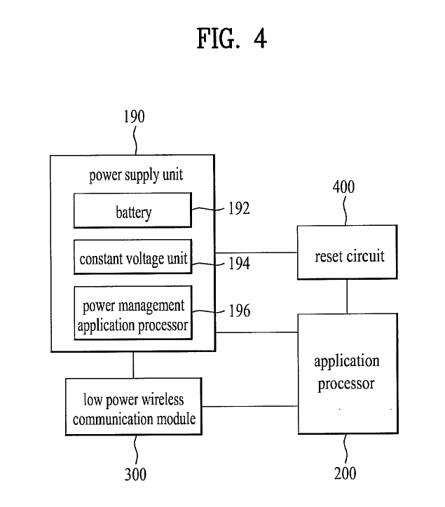

The mobile terminal including the reset circuit 400 failing to be illustrated in FIG. 1 may be schematically described with reference to FIG. 4.

FIG. 4 is a block diagram of a mobile terminal including a reset circuit according to the present invention.

Referring to FIG. 4, a mobile terminal according to the present invention may include a power supply unit 190, an application processor 200, a low power wireless communication module 300 and a reset circuit 400. The application processor 200 and the low power wireless communication module 300 shown in FIG. 4 may belong to the scopes of the controller 180 and the wireless communication unit 110 shown in FIG. 1, respectively. For clarity of the following description, reference numbers 200 and 300 shall be given to the application processor and the low power wireless communication module, respectively.

The power supply unit 190 plays a role in supplying a power necessary for operations of the respective components of the mobile terminal. In particular, the power supply unit 190 of the present invention may include a battery 192, a constant voltage unit 194 and a power management application processor 196.

The constant voltage unit 194 connected to the low power wireless communication module 300 adjusts a voltage supplied from the battery 192 into an operating voltage of the low power wireless communication module 300 and then outputs the adjusted voltage. The constant voltage unit 194 of the present invention may be understood as an upper concept of a regulator or an LDO (low drop output). In particular, whether to use the regulator or the LDO may be determined based on a voltage drop level of the voltage supplied from the battery 192.

For instance, if a difference between an input voltage of the constant voltage unit 194 and an output voltage of constant voltage unit 194 is smaller than a prescribed voltage difference, it may be able to implement the constant voltage unit 194 using the LDO. For another instance, if a difference between an input voltage of the constant voltage unit 194 and an output voltage of constant voltage unit 194 is greater than the prescribed voltage difference, it may be able to implement the constant voltage unit 194 using the regulator.

The power management application processor 196 controls a power supply to the application processor 200 from the battery 192. Moreover, the power management application processor 196 adjusts the voltage supplied to the application processor 200 in response to a workload of the application processor 200, thereby controlling the application processor 200 to be operated with a minimum power all the time. The power management application processor 196 may be implemented by hardware with PMIC (power management integrated chip), by which the present invention may be non-limited. The power management application processor 196 may be able to control whether to cut off the power supply to the application processor 200 and the memory 160, based on a remaining power level of the battery 192.

In case of attempting to cut off the power supply to the application processor 200, the power management application processor 196 generates a power-off signal and may be then able to transmit the generated signal to the application processor 200 in order to prevent user data saved in a volatile memory from being lost. If the application processor 200 performs a procedure for power cutoff, the power management application processor 196 may be able to cut off the power supply to the application processor 200 from the battery 192.

The application processor 200 activates an application saved in the memory 160 by command processing and computing and also controls an operation of the low power wireless communication module 300. In particular, the application processor 200 may be able to control the low power wireless communication module 300 by applying a control signal for activating/deactivating the low power wireless communication module 300 and a signal for designating an external device to pair with. In particular, the application processor 200 may be able to perform data communication with the low power wireless communication module 300 using UART (universal asynchronous receiver/transmitter) protocol.

Once the application processor 200 starts to be supplied with a power from the power supply unit 190, the application processor 200 may be able to provide the reset circuit 400 with a trigger signal for resetting the settings of the low power wireless communication module 300.

The low power wireless communication module 300 normally keeps operating under the control of the application processor 200. After the application processor 200 has been deactivated, the low power wireless communication module 300 may be able to independently operate irrespective of the application processor 200. In particular, the low power wireless communication module 300 receives a control signal for requesting to ignore a signal applied from the application processor 200, thereby escaping from the control conducted by the application processor 200. After the application processor 200 has been deactivated, the low power wireless communication module 300 may be able to maintain its active state by receiving an operating power from the power supply unit 190.

The reset circuit 400 performs the resetting or initialization on the low power wireless communication module 300 based on the trigger signal received from the application processor 200. In particular, the reset circuit 400, which is connected to the power supply unit 190, may be able to control the initialization of the low power wireless communication module 300 to proceed by temporarily interrupting the power supplied to the low power wireless communication module 300 by the power supply unit 190. Alternatively, the reset circuit 400, which is directly connected to the low power wireless communication module 300, is able to control the low power wireless communication module 300 to be initialized or reset.

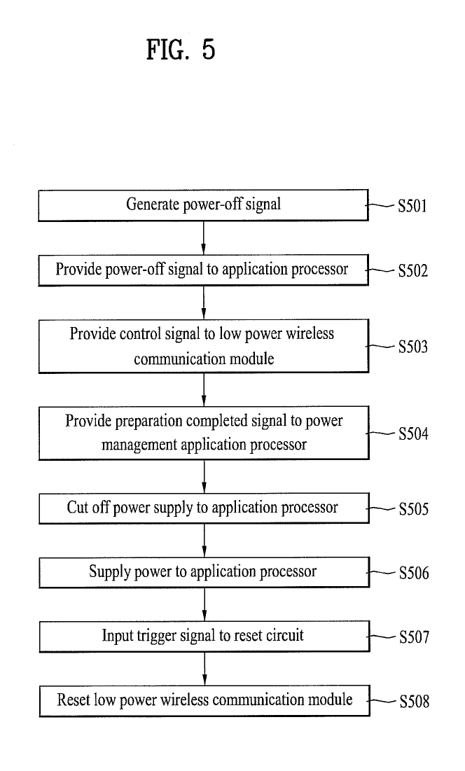

In the following description, the organic connection relations among the components shown in FIG. 4 are explained in detail with reference to FIG. 5.

FIG. 5 is a flowchart for operation of a mobile terminal according to the present invention.

Referring to FIG. 5, a step of generating a power-off signal may include the step of generating a power-off signal for cutting off a power supply to the components configuring the mobile terminal in response to a user input or a remaining power level of the power supply unit 190 [S501]. In particular, if a user presses a power button of the mobile terminal or a remaining power level of the battery 192 of the power supply unit 190 becomes equal to or lower than a first minimum limit, the power management application processor 196 of the power supply unit 190 may be able to generate the power-off signal.

For instance, if the remaining power level of the battery 192 becomes insufficient to further activate the application processor 200, the power management application processor 196 may be set to cut off the power supply to the application processor 200 and the memory 160. Cutting off the power supply to the application processor 200, when the remaining power level of the battery 192 is lowered to become equal to or smaller than the first minimum limit, is to prevent the battery 192 to be completely discharged. Such a lithium battery used for a mobile terminal as a lithium ion battery, a lithium polymer battery and the like has a problem that the life of the battery 192 may be shortened due to the full discharge of the battery 192. Moreover, if the battery 196 is prevented from being fully discharged, it may be able to maintain the activation of the low power wireless communication module 300 after the power of the mobile terminal has been turned off.

Once the power-off signal is generated, the power management application processor 196 may be able to provide the generated power-off signal to the application processor 200 [S502]. Having received the power-off signal, the application processor 200 transmits a control signal to the low power wireless communication module 300, thereby setting the low power wireless communication module 300 to ignore (or cut off) all signals forwarded in the future to its signal input terminal connected to the application processor 200 [S503]. Having received the control signal from the application processor 200, the low power wireless communication module 300 saves the settings in accordance with the control signal in its storage and then cuts off the signals applied in the future to the signal input terminal connected to the application processor 200, thereby operating out of a control range of the application processor 200. Moreover, when the power of the mobile terminal is turned off, the application processor 200 prevents an application from being forced to be ended in order to avoid data loss and controls user data to be saved in the memory 160, thereby preventing the user data from damaged.

The low power wireless communication module 300 may be able to enter a power saving mode from a normal mode by receiving an input of a control signal. If the power saving mode is entered, a power consumed in the saving mode becomes further reduced than a power consumed in the normal mode, thereby enabling the low power wireless communication module 300 to operate for long term after deactivation of the application processor 200.

For instance, the Bluetooth module operates in the normal mode while the application processor 200 is active. Having received a control signal from the application processor 200, the Bluetooth module may be set to cut off all signals inputted to its signal input terminal connected to the application processor 200 as soon as enters the BLE mode.

The aforementioned step S503 may be a mandatory step set to be executed before the application processor 200 is ended. Alternatively, the step S503 may be adjusted manually in response to user settings.

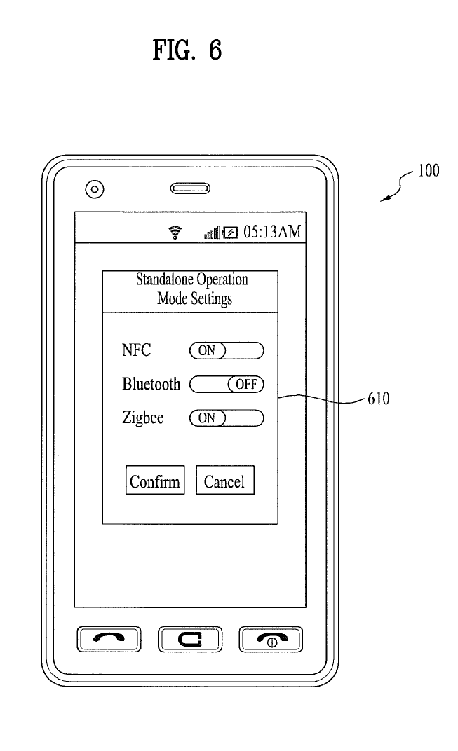

FIG. 6 is a diagram of display screen configuration provided to enable a user set up whether to independently operate a low power wireless communication module.

Referring to FIG. 6, through a menu screen 610 provided in the course of operating the mobile terminal, a user may be able to select whether to use the low power wireless communication module 300 despite that the application process or 200 has been deactivated. After the user settings have been saved in the memory 160, only if the user sets the low power wireless communication module 300 to be usable after the deactivation of the application processor 200, the step S503 can be performed. In the example shown in FIG. 6, if the user sets the low power wireless communication module 300 not to be operable independently, the application processor 200 may be able to provide the power management application processor 196 with a cutoff request signal for making a request for cutting off a power supply to the low power wireless communication module 300 as well. In case that a plurality of communication modules operable independently are partially set to be operable independently (e.g., NFC module and Zigbee module in FIG. 6), the application processor 200 may be able to control the control signal to be applied to the selected module(s) only.

Subsequently, the application processor 200 provides the power management application processor 196 with a preparation completed signal indicating that a power end preparation is completed [S504]. The power management application processor 196 then cuts off the power supply to the application processor 200 [S505].

After the power supply to the application processor 200 has been cut off, the low power wireless communication module 300 keeps being supplied with the power, thereby enabling to maintain its active state. For clarity of the following description, if the low power wireless communication module 300 is active after the cutoff of the power supply to the application processor 200, it may be named a standalone operation state of the low power wireless communication module 300.

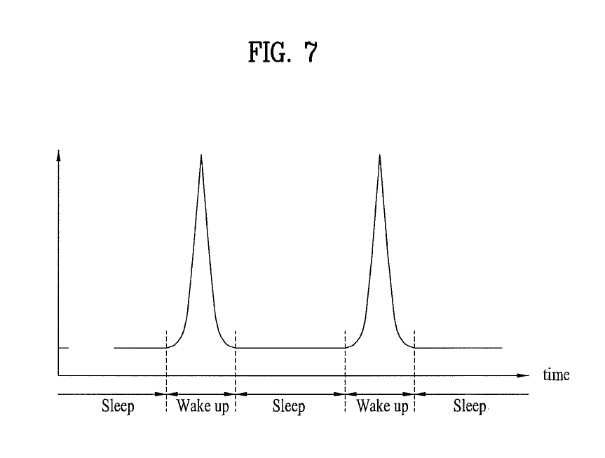

The low power wireless communication module 300 operating in the standalone operation state normally maintains a sleep state and wakes up periodically to check whether a signal transmitted from an external device exists. For instance, in case that a mode of the Bluetooth module is switched to a BLE (Bluetooth Low Entergy) mode, a current consumed by the Bluetooth module may be depicted as shown in FIG. 7. FIG. 7 is a graph of operation of a Bluetooth module that is a low power wireless communication module. Referring to FIG. 7, the Bluetooth module normally maintains a sleep state and periodically wakes up to detect a beacon signal from an access point (AP). Since a current consumed in the sleep state converges to 0, ‘sleep’ and ‘wake up’ are repeated to reduce the power consumption.

In case that the power management application processor 196 is in the standalone operation state, the low power wireless communication module 300 receives a wireless signal from an external device and may be then able to perform a preset operation. For instance, when the mobile terminal is turned off, if the low power wireless communication module 300 receives a wireless signal from an external device, the low power wireless communication module 300 may be able to provide a detected signal to the power management application processor 196. Having received the detected signal from the low power wireless communication module 300, the power management application processor 196 controls a power to be applied to the application processor 200, thereby enabling the mobile terminal to be turned on.

The mobile terminal may operate to be turned on. For another instance, in case that the low power wireless communication module 300 includes the NFC communication module, the NFC communication module comes in contact with an NFC reader, thereby settling such a payment as a transportation fee, a commodity price and the like. The NFC communication module may be applicable to a door entrance system by utilizing a previously saved employee ID number, a personal recognition information and the like.

Thereafter, if a power-on command is inputted through a user input, the power management application processor 196 may be able to control a power to be supplied to the application processor 200 [S506]. In particular, if the user presses the power button via a key input unit for prescribed duration or a remaining power level of the battery 192 becomes equal to or greater than a second minimum limit greater than the first minimum limit, the power management application processor 196 may be able to supply a power to the application processor 200. If the mobile terminal is turned on when the remaining power level is greater than the second minimum limit, the user may be able to normally use the mobile terminal by considering that the mobile terminal is charged enough to operate for a prescribed time.

Once the application processor 200 is activated, the application processor 200 may be able to input a trigger signal to the reset circuit 400 to activate [S507]. Once the trigger signal is inputted, the reset circuit 400 cuts off the power supplied to the low power wireless communication module 300 from the power supply unit 190, thereby controlling the low power wireless communication module 300 to be reset [S508]. In particular, in a manner of cutting the power provided to the low power wireless communication module 300 in the standalone operation state, the settings of the low power wireless communication module 300 are initialized and the low power wireless communication module 300 is set not to cut off a control signal applied from the application processor 200 anymore. In particular, if the power supply to the low power wireless communication module 300 is cut off, all data in a storage (not shown in the drawing) of the low power wireless communication module 300 are volatilized, thereby controlling the low power wireless communication module 300 to be reset.

According to the step S508, the reset circuit 400 is connected to the power supply unit 190 to reset the low power wireless communication module 300. Alternatively, it may be able to reset the low power wireless communication module 300 in different ways. For instance, the reset circuit 400 is directly connected to the low power wireless communication module 300, thereby providing the low power wireless communication module 300 with a reset signal for direct initialization. In doing so, the step S508 may be substituted with a step for the reset circuit 400 to apply a reset signal to the low power wireless communication module 300.

In the above-described process, when the application processor 200 is deactivated, the steps S501 to S503 of transmitting the control signal to the low power wireless communication module 300 may not need to be necessarily performed. For instance, in case that the low power wireless communication module 300 is set for the standalone operation from the factory release, since the low power wireless communication module 300 is not standalone-operable after the cutoff of the power supply to the application processor 200, the steps S501 to S503 may be skipped.

The operations of the reset circuit 400 in the above-described steps S507 and S508 are described in detail with reference to the accompanying drawings.

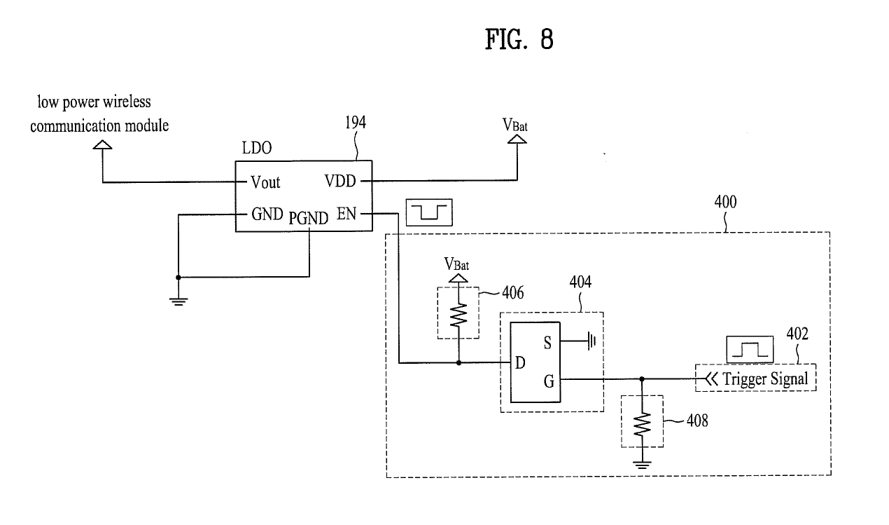

FIG. 8 is a diagram of circuitry to describe a reset circuit according to one embodiment of the present invention.

Referring to FIG. 8, the reset circuit 400 according to the present invention may include a trigger signal input terminal 402 configured to receive an input of a trigger signal from the application processor 200 and a switching device 404 configured to control whether to supply a power to the low power wireless communication module 300. Optionally, the reset circuit 400 may further include a pull-up resistor 406 and a pull-down resistor 408 for output adjustment.

In particular, the reset circuit 400 according to the present invention may be connectible to the constant voltage unit 194 of the power supply unit 190. For clarity of the following description, assume that the constant voltage unit of the present invention includes an LDO and that the switching device includes an N-type MOSFET. Moreover, in the example shown in FIG. 8, assume that the LDO is normally operable only if ‘High’ is inputted to an enable pin EN. In case that the switching device 404 includes the N-type MOSFET, the pull-up resistor 406 and the pull-down resistor 406 may be connectible to a drain of the MOSFET 404 and a gate of the MOSFET 404, respectively.

Referring to FIG. 8, a source of the MOSFET 404 is grounded and the drain of the MOSFET 404 may be connected to the enable pin of the LDO 194 and the pull-up resistor 406 connected to the battery 192. Moreover, the gate of the MOSFET 404 may be connected to the trigger signal input terminal 402 and the pull-down resistor 408 connected to the ground.

First of all, in case that the low power wireless communication module 300 is in the standalone operation state, the application processor 200 is unable to apply any signal to the trigger signal input terminal 402. Hence, a signal inputted to the gate may enter a state LOW by the pull-down resistor 408. In this case, since a voltage between the gate and the source is smaller than a threshold voltage of the MOSFET 404, the MOSFET 404 is in a cutoff state and any conduction does not occur between the drain and the source. Hence, a voltage of an output node of the drain may be handled as HIGH due to the pull-up resistor 406. Eventually, in case that the low power wireless communication module 300 is in the standalone operation state, a signal applied to the enable pin of the LDO 194 is HIGH and the LDO 194 is active. Hence the LDO 194 is able to drop a dropped voltage from the battery 192. The low power wireless communication module 300 receives the dropped voltage from the LDO 194 and is then standalone-operable.

Once the application processor 200 is active, the application processor 200 provides a trigger signal to the trigger signal input terminal 402 of the reset circuit 400. In doing so, the trigger signal may include a pulse that outputs HIGH for prescribed duration temporarily. And, the application processor 200 is able to the trigger signal once on switching to an active state from an inactive state. Yet, it may be unnecessary for the trigger signal to be provided once only. For instance, it may be able to raise accuracy of resetting the low power wireless communication module 300 in a manner of iteratively applying the trigger signal twice at least.

After the trigger signal has been inputted, if the state of the trigger signal input terminal 402 is switched to HIGH from LOW, a voltage HIGH may be inputted to the gate of the MOSFET 404. Hence, since the voltage between the gate and the source becomes higher than the threshold voltage of the MOSFET 404, a conduction channel is established between the drain and the source. Once the conduction channel is established between the drain and the source, a signal LOW is inputted to the enable pin of the LDO. Once the signal LOW is applied to the enable pin of the LDO 194, since the LDO 194 is disabled, it may be unable to normally supply the power to the low power wireless communication module 300. In particular, if the trigger signal is inputted to the trigger signal input terminal 402, the power supply to the low power wireless communication module 300 is cut off. Once the power supply to the low power wireless communication module 300 is cut off, the setting values of the low power wireless communication module 300 are all deleted and the low power wireless communication module 300 does not cut off a signal from the input terminal connected to the application processor 200 anymore.

In the example shown in FIG. 8, only if the signal HIGH is inputted to the enable pin of the LDO 194, the LDO 194 can be operated. On the other hand in case that the LDO 194 becomes operable only if the signal LOW is applied to the enable pin of the LDO 194, it may be able to implement the reset circuit 400 in a simple manner.

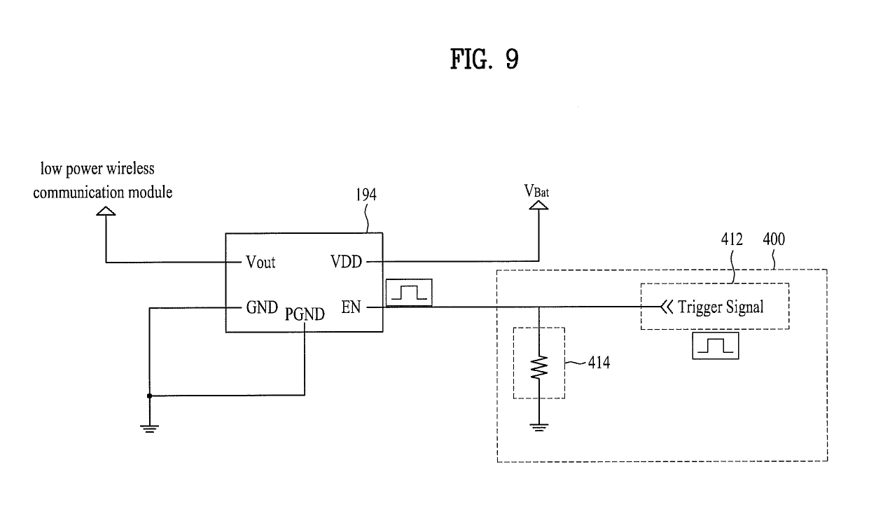

FIG. 9 is a diagram of circuitry to describe a reset circuit 400 according to one embodiment of the present invention. Unlike the former LDO shown in FIG. 8, assume that the LDO 194 shown in FIG. 9 is assumed as operable only if a signal LOW is applied.

Referring to FIG. 9, the reset circuit 400 may include a trigger signal input terminal 412 connected to an enable pin of the LDO 194 and a pull-down resistor 414 connected to the enable pin of the LDO 194.

When the application processor 200 is in an inactive state, a signal LOW is applied to the enable pin of the LDP 194 by the pull-down resistor 414. Hence, although the application processor 200 is deactivated, the low power wireless communication module 300 may be standalone-operable by receiving a voltage outputted from the LDO 194.

Thereafter, as the application processor 200 is activated, if a trigger signal is inputted to the trigger signal input terminal 412, a signal applied to the enable pin of the LDO 194 become HIGH. Hence, the LDO 194 stops operating temporarily. If so, the power supply to the low power wireless communication module 300 is cut off as well, thereby resetting the low power wireless communication module 300.

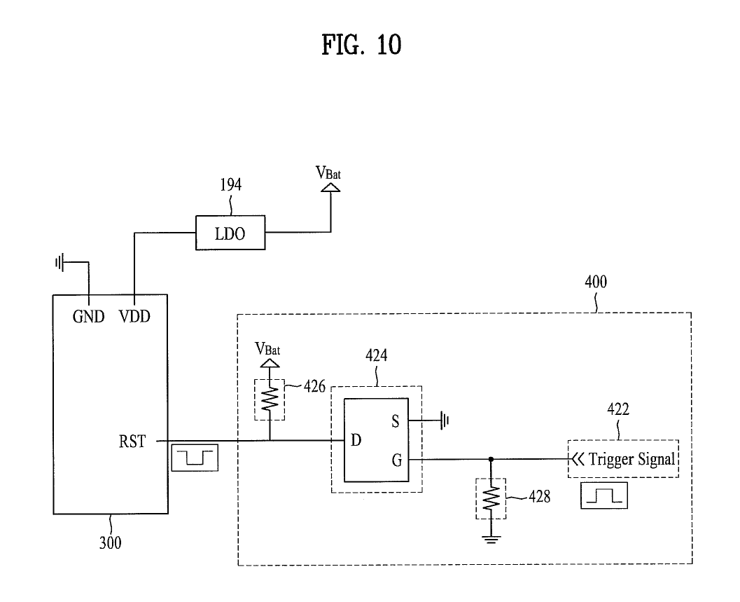

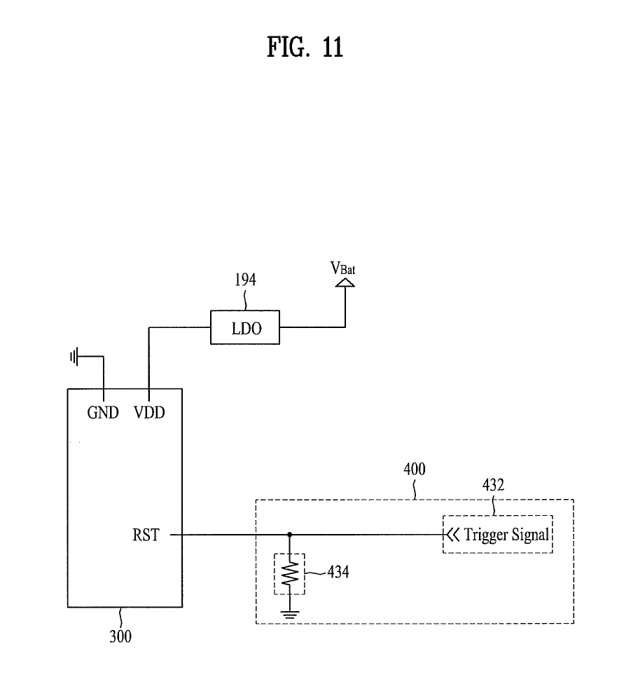

According to the descriptions with reference to FIG. 8 and FIG. 9, the reset circuit 400 connected to the power supply unit 190 controls whether to supply the power to the low power wireless communication module 300 from the power supply unit 190, thereby resetting the low power wireless communication module 300, by which the present invention may be non-limited. In case that the low power wireless communication module 300 supports a reset pin, referring to FIG. 10 or FIG. 11, an output terminal of the reset circuit 400 may be directly connected to the low power wireless communication module 300.

FIG. 10 is a diagram for one example of circuitry in case of resetting a low power wireless communication module 300 when a reset circuit 400 is directly connected to the low power wireless communication module 300.

Referring to FIG. 10, an output terminal of the reset circuit 400 may be directly connected to a reset pin RST of the low power wireless communication module 300. In the example shown in FIG. 10, assume that the low power wireless communication module 300 is reset when a signal LOW is applied to the reset pin RST of the low power wireless communication module 300. In doing so, the reset circuit 400 is directly connected to the reset pin RST of the low power wireless communication module 300, thereby controlling the low power wireless communication module 300 to be reset.

In particular, while the low power wireless communication module 300 is in a standalone operation state, since a signal applied to the reset pin RST of the low power wireless communication module 300 is HIGH, the setting of the low power wireless communication module 300, i.e., the setting of cutting off all signals applied from the application processor 200 is maintained. Thereafter, if the application processor 200 is activated, a signal LOW is temporarily applied to the reset pin RST of the low power wireless communication module 300, thereby initializing the setting of the low power wireless communication module 300. As the low power wireless communication module 300 is reset, the setting of cutting off all signals applied from the application processor 200 is initialized as well. Therefore, the low power wireless communication module 300 is operated under the control of the application processor 200.

When a signal HIGH is applied to a reset pin, if the low power wireless communication module 300 is reset, unlike FIG. 10, the reset circuit 400 shown in FIG. 9 may be applied as it is.

FIG. 11 is a diagram for another example of circuitry in case of resetting a low power wireless communication module 300 when a reset circuit 400 is directly connected to the low power wireless communication module 300.

Referring to FIG. 11, while the low power wireless communication module 300 is in the standalone operation state (i.e., the application processor 200 is inactive), a signal LOW is maintained at the reset pin RST of the low power wireless communication module 300 due to a pull-down resistor 434. Thereafter, as the application processor 200 is activated, if a trigger signal in state HIGH is temporarily inputted to a trigger signal input terminal 432, since a state of a signal applied to the reset pin RST of the low power wireless communication module 300 is switched to HIGH, the low power wireless communication module 300 can be reset.

The circuitry shown in FIGS. 8 to 11 may not follow the corresponding drawings. Alternatively, the switching device shown in FIGS. 8 to 11 may include one of a P-type MOSFET, a transistor, a thyristor and the like instead of the N-type MOSFET. Alternatively, the switching device shown in FIGS. 8 to 11 may include a physical switch instead of the electrical switch. In the examples shown in FIGS. 8 to 11, the input or output of the switching device is changed using such a digital device as NOT gate and the like, which may come within the scope of the appended claims and their equivalents.

According to the embodiments mentioned in the foregoing description, the present invention is applied to the low power wireless communication module 300, which may not be limited to wireless communication modules. For instance, it is a matter of course that the present invention is applicable to MCU (microcontroller unit) applied to sensors. The MCU may be operable with low power by repeatedly performing ‘sleep’ and ‘wake up’ to acquire prescribed physical property (e.g., pressure, temperature, humidity, etc.). When the application processor is deactivated, if the MCU is set to operate in standalone operation mode, the setting of the MCU may be initialized through the reset circuit 400 of the present invention after re-activation of the application processor 200.

Thus, it is a matter of course that the present invention is applicable to such a power-saving operable item, which can operate without the help of the application processor 200, as an MCU applied to sensors for detecting desired physical properties.

Accordingly, embodiments of the present invention provide various effects and/or features.

According to at least one of embodiments of the present invention, when a mobile terminal is in an off-state, if the mobile terminal is turned on, the setting of a low power wireless communication module is automatically initialized, thereby utilizing the low power wireless communication module in the off-state of the mobile terminal.

It will be appreciated by those skilled in the art that the present invention can be specified into other form(s) without departing from the spirit or scope of the inventions.

In addition, the above-described methods can be implemented in a program recorded medium as computer-readable codes. The computer-readable media may include all kinds of recording devices in which data readable by a computer system are stored. The computer-readable media may include ROM, RAM, CD-ROM, magnetic tapes, floppy discs, optical data storage devices, and the like for example and also include carrier-wave type implementations (e.g., transmission via Internet). Further, the computer may include the controller 180 of the terminal.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a power supply unit configured to supply an operation power;
an application processor activated by being supplied with a power from the power supply unit;
a low power wireless communication module configured to maintain an active state by being supplied with the power from the power supply unit despite that the mobile terminal is in an inactive state, and be cut off a signal inputted from the application processor if the application processor is in the inactive state; and
a reset circuit configured to receive a trigger signal from the application processor after activation of the application processor, and reset a setting of the low power wireless communication module based on the trigger signal.

2. The mobile terminal of claim 1, wherein if the application processor is switched to the active state from the inactive state, the application processor delivers the trigger signal to the reset circuit.

3. The mobile terminal of claim 1, wherein the reset circuit resetting the low power wireless communication module by temporarily cutting off the power supplied to the low power wireless communication module from the power supply unit.

4. The mobile terminal of claim 3, the power supply unit comprising:
a battery configured to store electric energy therein; and
a constant voltage unit outputting a low voltage to the low power wireless communication module by dropping a voltage applied from the battery to the low voltage for operating the low power wireless communication module.

5. The mobile terminal of claim 4, wherein the reset circuit controls whether to supply the power to the low power wireless communication module in a manner of controlling the constant voltage unit to be set in either an enable state or a disable state.

6. The mobile terminal of claim 5, the reset circuit comprising:
a trigger signal input terminal configured to receive an input of the trigger signal from the application processor; and
a switching device connected to the constant voltage unit, the switching device switching an output value to set the constant voltage unit in either the enable state or the disable state based on the trigger signal.

7. The mobile terminal of claim 6, wherein the switching device comprises an N-type MOSFET, wherein a drain of the N-type MOSFET is connected to the battery and a pull-up resistor connected to the constant voltage unit, wherein a source of the N-type MOSFET is grounded, and a gate of the N-type MOSFET is connected to a pull-down resistor connected to a ground and the trigger signal input terminal.

8. The mobile terminal of claim 1, wherein the reset circuit is connected to a reset pin of the low power wireless communication module and wherein the reset circuit controls the low power wireless communication module to be reset by adjusting a signal applied to the reset pin.

9. The mobile terminal of claim 1, wherein if the application processor receives a power-off signal from the power supply unit, the application processor applies a control signal to enable the low power wireless communication module to maintain activation after deactivation of the application processor.

10. The mobile terminal of claim 9, wherein the application processor provides the power supply unit with a preparation completed signal in response to the power-off signal and wherein if receiving the preparation completed signal, the power supply unit cuts off a power supply to the application processor.

11. The mobile terminal of claim 1, the power supply unit comprising:
a battery storing electric energy;
a constant voltage unit outputting a low voltage to the low power wireless communication module by dropping a voltage applied from the battery into the low voltage for operating the low power wireless communication module; and
a power management application processor controlling the power supply to the application processor and the low power wireless communication module.

12. The mobile terminal of claim 1, wherein if a remaining power level of the battery exceeds a preset level, the power management application processor controls the application processor to be activated by supplying the power to the application processor.

13. The mobile terminal of claim 1, wherein when the application processor is in the inactive state, if the low power wireless communication module in the active state detects a beacon signal from an external device, the power supply unit controls the application processor to enter the active state from the inactive state.

14. The mobile terminal of claim 1, wherein the low power wireless communication module supports a power saving mode for repeatedly performing a sleep and a wake-up.

15. The mobile terminal of claim 14, wherein the low power wireless communication module comprises a Bluetooth module supportive of a Bluetooth Low Energy.

16. The mobile terminal of claim 1, wherein the application processor and the low power wireless communication module perform data communication with each other using UART (universal asynchronous receiver transmitter) protocol.

17. A method of controlling a mobile terminal having a low power wireless communication module configured to maintain an active state by being supplied with a power from a power supply unit despite that an application processor is in an inactive state, comprising the steps of:
switching the inactive state of the application processor to the active state;
providing a trigger signal to a reset circuit to reset a setting of the low power wireless communication module; and
controlling the reset circuit to initialize the setting of the low power wireless communication module based on the trigger signal.
